(19) United States
(12) Patent Application Publication
(10) Pub. No.: US 2026/0036868 A1
(43) Pub. Date: Feb. 5, 2026

(54) INCOMMENSURATE OPTICAL FREQUENCY COMBS GENERATED USING FLOQUET TOPOLOGICAL COUPLED RESONATOR ARRAYS

(71) Applicant: Northeastern University, Boston, MA (US)

(72) Inventors: Sunil Mittal, Medford, MA (US); Seyed Danial Hashemi, Boston, MA (US)

(21) Appl. No.: 19/283,667

(22) Filed: Jul. 29, 2025

Related U.S. Application Data
(60) Provisional application No. 63/677,619, filed on Jul. 31, 2024.

(51) Int. Cl. G02F 1/35; G02F 1/365

(52) U.S. Cl. CPC G02F 1/3507; G02F 1/365; G02F 2203/56

(57) ABSTRACT

The present disclosure provides an optical frequency comb source comprising a two-dimensional array of coupled resonators with spatially varied coupling strengths operating in an anomalous floquet topological phase having topological edge states appearing in all topological band gaps. The array generates, when pumped with radiation at a frequency corresponding to one of the topological edge states, an incommensurate optical frequency comb having multiple edge bands irregularly spaced in the frequency domain. The incommensurate optical frequency comb is associated with floquet topological soliton molecules circulating at an edge of the array. Methods of generating such optical frequency combs are also provided.

### RELATED APPLICATION(S)

This application claims the benefit of priority to U.S. Provisional Application No. 63/677,619, filed Jul. 31, 2024, which is herein incorporated by reference in its entirety.

### TECHNICAL FIELD

The present disclosure relates to optical frequency comb generation, and more particularly to generating optical frequency combs with irregularly spaced, frequency locked comb lines.

### BACKGROUND OF THE DISCLOSURE

Optical frequency combs are powerful tools for applications in metrology, spectroscopy, and precision timekeeping. However, current methods for generating frequency combs, for example, using ring resonators with Kerr nonlinearity, generate fundamentally identical spectra consisting of equally spaced lines in frequency. Additionally, conventional comb generation techniques offer limited flexibility in tuning the comb line spacing and tailoring the comb spectrum for specific applications.

### SUMMARY

Recent advances in topological photonics have opened new possibilities for manipulating light propagation in photonic structures. By engineering synthetic gauge fields and non-trivial band topologies in coupled resonator arrays, novel phenomena such as unidirectional/helical edge states that have approximately linear dispersion and are inherently robust against defects have been shown to result in higher efficiency and robustness in nonlinear processes, for example, for generating quantum states of light.

The present application is directed towards using coupled resonator arrays hosting edge states in multiple topological edge bands for optical frequency comb generation. Here, an incommensurate comb is generated, whose frequency spectrum shows incommensurate gaps, and therefore, cannot be described using the conventional definition of combs as a set of equidistant lines.

In some implementations, an incommensurate optical frequency comb source comprises a two-dimensional array of coupled resonators with spatially varied coupling strengths operating in an anomalous floquet topological phase having topological edge states appearing in all topological band gaps, the array generating, when pumped with a pump radiation at a frequency corresponding to one of the topological edge states, an incommensurate optical frequency comb having multiple edge bands irregularly spaced in the frequency domain.

In some implementations, the resonator geometry comprises a ring resonator.

In some implementations, the two-dimensional array comprises a square lattice of ring resonators.

In some implementations, the spatially varied coupling strengths are parameterized as κa=sin (|θA|) and κb=sin (|θB|), and θA and θB are coupling parameters.

In some implementations, θA=0.45π and θB=0.05π are chosen to operate in the anomalous floquet regime

In some implementations, the optical frequency comb source further comprises an input-output waveguide coupled to one of the ring resonators for injecting the pump radiation and out-coupling the generated comb.

In some implementations, the input-output waveguide is coupled to the ring resonator with a coupling coefficient κIO.

In some implementations, the ring resonators have an anomalous dispersion.

In some implementations, the anomalous dispersion is characterized by a second-order dispersion parameter D2=4×10−6 ΩR, where ΩR is a free spectral range of the ring resonators.

In some implementations, a method of generating an optical frequency comb comprises providing a two-dimensional array of coupled ring resonators having spatially varied coupling strengths and operating in an anomalous floquet topological phase with topological edge states appearing in all band gaps; and generating an incommensurate optical frequency comb having multiple edge bands irregularly spaced in the frequency domain by pumping the two-dimensional array at a frequency corresponding to one of the topological edge states.

In some implementations, the method further comprises injecting at least one pump radiation and out-coupling the generated comb through at least one input-output waveguide coupled to at least one of the ring resonators.

In some implementations, the incommensurate optical frequency comb comprises comb lines that are not all equidistant but are phase-locked.

In some implementations, the incommensurate optical frequency comb comprises edge states in multiple edge bands interleaved by bulk bands of the two-dimensional array.

In some implementations, generating the incommensurate optical frequency comb comprises forming floquet topological soliton molecules that circulate at an edge of the array.

In some implementations, the floquet topological soliton molecules exhibit phase-locking across multiple rings on the edge of the array.

In some implementations, the incommensurate frequency comb can be tuned to a commensurate comb, with equal frequency spacing, by tuning θA and θB.

In some implementations, the frequency spacing between the comb lines can be tuned by creating a defect on the edge of the lattice and tuning the effective length of the edge.

In some implementations, the frequency spectrum is topologically robust against imperfections and disorders in the ring resonators of the lattice.

The foregoing general description of the illustrative implementations and the following detailed description thereof are merely exemplary aspects of the teachings of this disclosure and are not restrictive.

### BRIEF DESCRIPTION OF THE DRAWINGS

The accompanying drawings, which are incorporated into and constitute a part of this specification, illustrate various exemplary implementations and together with the description, serve to explain the principles of the disclosed implementations.

FIG. 1 depicts a flowchart illustrating one implementation of a method for generating an optical frequency comb.

FIG. 2A depicts a schematic view of one implementation of a resonator array with a corresponding intensity graph.

FIG. 2B depicts one implementation of a resonator network with a corresponding phase diagram.

FIGS. 2C-2D show transmission and band structure data for one implementation of a photonic system.

FIG. 2E depicts edge and bulk characteristics for one implementation of a coupled resonator system.

FIG. 2F illustrates combined edge and bulk characteristics for one implementation of a coupled resonator system.

FIG. 2G illustrates combined edge and bulk characteristics for one implementation of a coupled resonator system.

FIG. 3A shows a graph of normalized frequency detuning versus normalized wavevector for one implementation of a coupled resonator system.

FIG. 3B depicts a graph of pump absorption versus normalized frequency detuning, for one implementation of a coupled resonator system.

FIG. 3C is a graph of comb power versus normalized frequency detuning, for one implementation of a coupled resonator system.

FIG. 3D shows intensity distribution patterns in one implementation of a two-dimensional array of coupled resonators.

FIG. 3E depicts a graph of normalized time evolution versus iterations for one implementation of a coupled resonator system.

FIG. 3F illustrates a graph of comb power versus normalized frequency for one implementation of a coupled resonator system.

FIG. 3G shows a graph of frequency detuning versus FSR index for one implementation of a coupled resonator system.

FIG. 3H depicts a graph of comb power measurements versus normalized frequency detuning, for one implementation of a coupled resonator system.

FIG. 4A illustrates a graph of frequency detuning versus normalized wave vector for one implementation of a coupled resonator system.

FIG. 4B shows an absorption spectrum graph of pump characteristics, for one implementation of a coupled resonator system.

FIG. 4C depicts a graph of comb power versus normalized frequency detuning, for one implementation of a coupled resonator system.

FIG. 4D illustrates intensity distribution of a topological soliton state in one implementation of an array of coupled resonators.

FIG. 4E shows a graph of normalized time evolution versus iterations, for one implementation of a coupled resonator system.

FIG. 4F depicts a graph of comb power versus normalized frequency for one implementation of a coupled resonator system.

FIG. 4G illustrates a graph of FSR index versus normalized frequency detuning, for one implementation of a coupled resonator system.

FIG. 4H shows a graph of comb power versus normalized frequency detuning, for one implementation of a coupled resonator system.

FIG. 5A depicts an intensity plot of edge states routing around a defect in a lattice

structure.

FIG. 5B depicts a graph of comb power versus normalized frequency, in the implementation of FIG. 5A.

FIG. 5C depicts a graph of comb power versus normalized frequency, showing a decrease in comb line spacing, in the implementation of FIG. 5A.

FIGS. 5D-5G circulation of a soliton pulse generated in a lattice for different time intervals, in the implementation of FIG. 5A.

### DETAILED DESCRIPTION

Reference will now be made in detail to the exemplary implementations of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

An optical frequency comb (OFC) is a source of light whose frequency spectrum consists of equidistant frequencies (lines), forming a comb-like structure that acts as a ruler of light, in that it measures the frequencies of light waves spanning from invisible to visible. OFCs emerge naturally in mode-locked lasers. OFCs have led to unprecedented advancements, for example, in precision metrology of time and frequency, and spectroscopy. Recent advances in generating coherent (phase-locked) OFCs on semiconductor chips have led to orders of magnitude reduction in their size, from meter-scale to a few tens of micrometers-scale, and revolutionized a host of diverse applications such as ultra-compact on-chip clocks, on-chip spectroscopy, on-chip terabit-scale transceivers for optical communications, ultra-low noise generation and processing of radio-frequency (RF) signals, on-chips light detection and ranging (LiDARs) and even extending to optical computation in the form of time-frequency-multiplexed optical neural networks (ONNs). Currently, such on-chip broadband OFCs are generated predominantly by using single-ring resonators that exhibit Kerr optical nonlinearity. Current platforms for generating on-chip OFCs rely on using single resonators with optical nonlinearities. This severely limits efficiency, agile tunability, minimum line spacing, and flexibility in engineering comb spectra to suit desired applications.

Proposed herein is the generation of an incommensurate comb whose frequency spectrum shows incommensurate gaps, that is, the comb lines within a comb are not all equally spaced. In certain implementations, some of the comb lines are equally spaced while others of the comb lines are not. In these implementations, the comb spectrum cannot be described using the conventional definition of combs as a set of equidistant lines.

Implementations of the present application include mode locking. With mode locking, the comb lines have a minimum line width set by the linewidth of the pump laser. This narrow linewidth enables ultra-low-noise generation of low-noise RF signals on a photonic chip.

Further, implementations of the present disclosure enable low-noise radio frequency signal generation used in very precise communication. Such implementations may be especially relevant for defense or niche applications. These implementations can also be relevant for synchronizing GPS, where precision is important.

This incommensurate comb is achieved by using two-dimensional arrays of coupled resonators that are engineered to implement the anomalous floquet topological phase, giving rise to topological edge states in the array. This engineering generates a comb that spans multiple edge bands of the array, interleaved by bulk bands.

The proposed incommensurate combs could drive transformative changes in applications of OFCs, for example, in the field of microwave photonics for ultra-low noise generation of RF signals. The incommensurate nature of the comb would facilitate simultaneous access to two mode-locked RF signals for much greater flexibility in generating signals at different frequencies. This contrasts with conventional combs that provide access to only a single RF frequency.

OFCs may be manufactured on a chip, where light keeps circulating in resonators. Current platforms for generating on-chip OFCs rely mostly on using single resonators with optical nonlinearities. This severely limits efficiency, agile tunability, minimum line spacing, and flexibility in engineering comb spectra to suit desired applications.

Applications of the frequency comb chips can include use as transmitters, used for sending data through internet or sending data through different wavelengths and frequencies of light. Use in autonomous cars is another potential application, where a source of light is needed to send out and return to calculate the distance. Here, the comb, when mode-locked, can generate a pulse of light for this purpose.

Here, the generation of a completely novel class of soliton combs, the floquet topological soliton combs, is described, emerging in two-dimensional arrays of strongly coupled resonators engineered using floquet topology. Specifically, using the anomalous floquet phase, the generation of novel incommensurate combs is realized, where, unlike conventional combs, the comb lines are not equidistant but still phase-locked.

These incommensurate combs are generated by self-organized floquet topological soliton molecules that exhibit phase-locking across a few rings on the edge of the lattice. Furthermore, it is shown that these floquet topological solitons are indeed robust against defects. Results introduce a new paradigm of using floquet engineering in strongly coupled nonlinear resonator arrays to generate coherent combs with novel and unconventional spectra that go beyond those generated using conventional single or weakly coupled resonators.

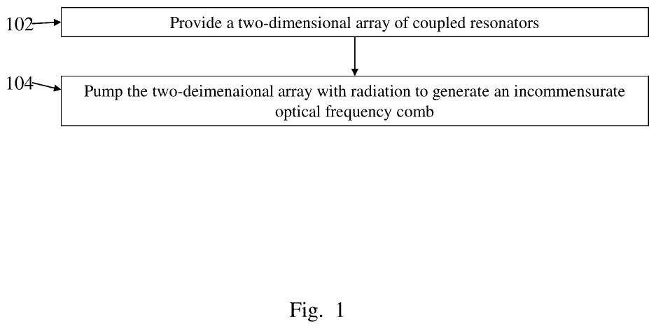

FIG. 1 illustrates a method 100 for generating OFCs using a two-dimensional array of coupled resonators. In brief overview, method 100 includes a step 102 of providing a two-dimensional array of coupled resonators having spatially varied coupling strengths and operating in an anomalous floquet topological phase with topological edge states appearing in all bands and a step 104 of generating an incommensurate OFC having multiple edge bands irregularly spaced in the frequency domain by pumping the two-dimensional array at a frequency corresponding to one of the topological edge states.

Still referring to FIG. 1, and in greater detail, in step 102 the two-dimensional array of coupled resonators may be configured as a resonator network of strongly coupled ring resonators. The resonator network may be engineered to exhibit floquet topology. The array may have spatially varied coupling strengths between the ring resonators.

The coupling strengths could be varied continuously across the array, following a mathematical function such as a linear gradient or exponential decay from one edge to another. Alternatively, the coupling strengths could be varied discretely, with different constant values in distinct regions or zones of the array. The coupling strengths could be dynamically tunable, using electro-optic or thermo-optic effects to adjust the coupling in real-time. The coupling strengths could be implemented using different physical mechanisms, such as evanescent field coupling or directional couplers. The coupling strengths could be engineered to have anisotropic properties, with different strengths along different axes of the 2D array. The coupling strengths could incorporate non-reciprocal elements, allowing for asymmetric coupling between adjacent resonators. The spatial variation of coupling strengths could be designed to compensate for fabrication imperfections or environmental factors that would otherwise perturb the desired topological properties. The coupling strengths could be varied not just spatially, but also spectrally, with different coupling strengths for different wavelength ranges.

In some implementations, the two-dimensional array comprises a square lattice of ring resonators. Alternatively, the array may comprise:
a hexagonal lattice of ring resonators, providing different symmetry properties and potentially altering the topological edge states;
a triangular lattice of ring resonators, which could offer unique band structures and edge state characteristics;
a rectangular lattice of ring resonators with different spacing along different axes, allowing for anisotropic coupling strengths;
a quasi-periodic arrangement of ring resonators, such as a Penrose tiling pattern, which could introduce novel topological properties;
a lattice with intentionally introduced defects or irregularities, potentially altering the edge state properties that enable tuning of comb line spacing;
a lattice with varying ring resonator sizes, where the resonator dimensions change systematically across the array to create a graded index effect;
a reconfigurable lattice where the coupling strengths between resonators can be dynamically tuned using electro-optic or thermo-optic effects; or
a lattice with non-uniform spacing between resonators, creating regions of stronger and weaker coupling to tailor the topological properties.

The ring resonators may have an anomalous dispersion characterized by a second-order dispersion parameter D2=4×10-6 ΩR, where ΩR is the free spectral range of the ring resonators. In some implementations, the ring resonators could be designed to have normal dispersion. In other implementations, the spatially varied coupling strengths may be parametrized as κa=sin (|θA|) and κb=sin (|θB|), where θA and θB are coupling parameters. In some implementations, θA=0.45π and θB=0.05π. The range for these coupling parameters may be chosen to operate in the anomalous Floquet topological phase according to 214.

Still referring to FIG. 1, and in greater detail, the method continues at step 104 by generating an incommensurate OFC having multiple edge bands irregularly spaced in the frequency domain by pumping the two-dimensional array at a frequency corresponding to one of the topological edge states. In some implementations, the two-dimensional array may be pumped at multiple frequencies simultaneously, corresponding to different topological edge states, to generate an incommensurate OFC with enhanced spectral coverage and complexity. In other implementations, the pump frequency may be dynamically tuned to sweep across multiple edge states, producing a time-varying incommensurate OFC with evolving spectral characteristics. In still other embodiments, a broadband pump source may be used that spans multiple edge states to excite a wider range of edge bands simultaneously. In still other implementations, pulse shaping techniques may be employed on the pump radiation to selectively excite specific combinations of edge states and tailor the resulting incommensurate OFC spectrum. Other implementations may: introduce controlled disorder or defects in the array to modify the edge state frequencies and generate unique incommensurate OFC patterns; apply external fields (e.g. electric, magnetic) to tune the edge state frequencies in situ and dynamically control the incommensurate OFC generation; cascade multiple two-dimensional arrays with different topological phases to produce a hierarchical incommensurate OFC with nested irregular frequency spacings; utilize nonlinear optical effects in the array material to enable frequency mixing between edge states and create additional spectral components in the incommensurate OFC; implement active feedback control to stabilize and optimize the generation of specific incommensurate OFC patterns by dynamically adjusting the pump conditions; or exploit the interplay between edge and bulk states through selective pumping to create hybrid incommensurate OFCs with both edge and bulk spectral components.

The generated comb may have multiple edge bands that are irregularly spaced in the frequency domain. This irregular spacing of edge bands may be a characteristic feature of the incommensurate OFC generated by the method 100, which also may feature comb lines that are not equidistant, but are phase locked. In some implementations, the OFC may span multiple edge bands interleaved by bulk bands of the two-dimensional array.

In some implementations, the method 100 may further comprise injecting the pump radiation and out-coupling the generated comb through an input-output waveguide coupled to one of the ring resonators.

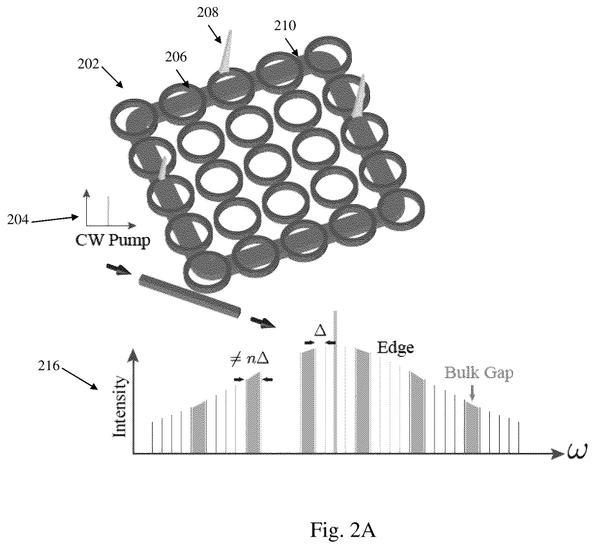

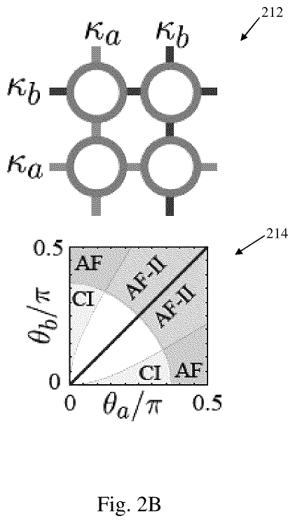

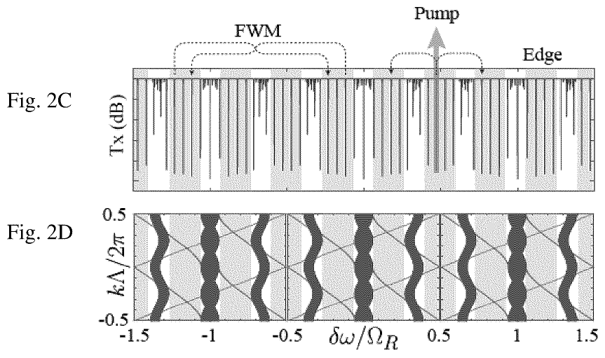

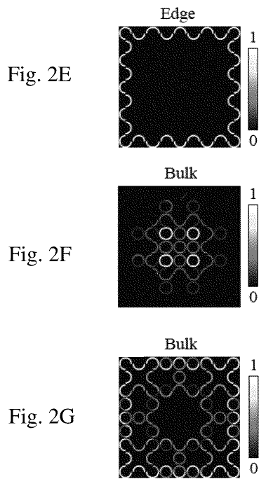

FIG. 2A illustrates a schematic view of one implementation of a ring resonator array. The ring resonator array 202 shown in FIG. 2A includes an outer ring formed of multiple resonator rings 206 arranged in a square pattern. The resonator rings 206 may be evanescently interconnected to their nearest neighbors by one or more coupling elements. Evanescent interconnection may refer to a method of transferring energy or information between two optical or electromagnetic systems using evanescent waves. These waves are a type of electromagnetic wave that exists only near the boundary of a medium, decaying exponentially with distance, and which do not propagate like regular waves.

Coupling strengths between the resonator rings 206 may be dependent on their location in the array 202. In some cases, the coupling strengths between resonator rings 206 may be parameterized as κₐ=sin (|θ_{A}|) and κ_{b}=sin (|θ_{B}|), where θ_{A} and θ_{B} are parameters that may vary based on the location in the array. With this arrangement of coupling strengths, a unit cell of the lattice includes four resonators. Accordingly, in this arrangement, the lattice can host a maximum of four bands. However, the topology of these bands is dictated by the particular choice of coupling strengths κa and κb. In particular, depending on the choice of coupling strengths, the lattice can host the anomalous floquet (AF) topological phase or the Chern insulator (CI) phase. Edge rings 210 correspond to the rings that are positioned along the perimeter of the array 202.

A continuous wave (CW) indicator graph 204 shows the magnitude of optical pumping into the system. In some implementations, the CW indicator graph 204 may indicate counter-clockwise pumping of the ring resonator array.

In some implementations, generating the incommensurate OFC comprises forming floquet topological soliton molecules that circulate at an edge of the array. The floquet topological molecules may exhibit phase-locking across multiple rings on the edge of the array.

The floquet comb soliton molecule 208 is generated by the input frequency pump. Each pulse in the floquet comb soliton molecule 208 is phase-locked, that is, that their relative position in the rings is the same. As time evolves, this Floquet-soliton molecule circulates around the edge in the counter-clockwise direction. Furthermore, because of the unique nature of this Floquet system, neither soliton completes a round-trip in the single ring. This is in contrast to the conventional single-ring solitons, where the soliton is defined as a non-dispersive pulse circulating in the ring resonator. It is noted that the relative intensities of the three solitons oscillate as a function of time, similar to that observed for breathing solitons in single-ring resonators.

Below the ring resonator array, an intensity graph 216 displays the spectral characteristics of the system. The intensity graph 216 may show the relationship between intensity and frequency. In some cases, the intensity graph 216 may indicate various bands and gaps in the frequency spectrum, including edge and bulk gap regions.

FIG. 2B illustrates one implementation of a unit cell 212 and an associated phase diagram 214. The unit cell 212 may include a 2×2 array of ring resonators arranged in a square configuration. In some cases, the resonators in the unit cell 212 may be interconnected with coupling elements denoted by κₐ and κ_{b}. The coupling strengths κₐ and κ_{b} may be parameterized as: κₐ=sin (|θ_{A}|) and κ_{b}=sin (|θ_{B}|), where θ_{A} and θ_{B} are parameters that may vary based on the location in the unit cell 212.

In some implementations, the unit cell 212 may exhibit an anomalous floquet phase where edge states emerge even when all bulk bands have a zero Chern number. This anomalous floquet phase corresponds to the AF region in the phase diagram 214.

The unit cell 212 may also exhibit a Chern insulator phase where bulk bands have non-zero Chern number. This Chern insulator phase corresponds to the CI region in the phase diagram 214.

The phase diagram 214 may map how different combinations of coupling strengths lead to distinct operational regimes in the unit cell 212. In some cases, the topology of the bands in the unit cell 212 may be dictated by the particular choice of coupling strengths κₐ and κ_{b}.

The transmission and band structure data for the resonator network in the unit cell 212 are illustrated in FIGS. 2C-2D. FIG. 2C shows the transmission spectrum of the system measured in decibels (dB). The transmission spectrum exhibits periodic dips corresponding to the resonances of the coupled ring resonator array. The vertical arrow in the transmission spectrum indicates one instantiation of the pump signal used to excite the system.

FIG. 2D presents the band structure of the unit cell 212, showing the relationship between the normalized wave vector k and the normalized frequency detuning δω/ΩR. The band structure is characterized by periodic, interleaved regions of edge and bulk bands. The shaded regions represent the bands that host edge states. As shown in FIG. 2D, the shaded regions form curved patterns that repeat periodically across the frequency range.

In some implementations, the transmission spectrum and band structure may be closely related. As shown in FIGS. 2C and 2D, the dips in the transmission spectrum shown in FIG. 2C correspond to the band gaps between the shaded regions in the band structure of FIG. 2D.

The x-axis in both FIGS. 2C and 2D spans a normalized frequency detuning range from −1.5 to 1.5. This normalization is with respect to the free spectral range (FSR) of the individual ring resonators in the array. Shown in FIG. 2D is the transmission spectrum and band structure of the lattice for the AF phase at θ_{A}=0.45π, and θ_{B}=0.05π. θ_{A}, and θ_{B} may range from 0 to 1. Edge bands are indicated by the shaded regions. The spectrum repeats every FSR of the ring resonators, and the band structure is calculated for a semi-infinite lattice, with k being the momentum and Λ the periodicity of the lattice.

In some implementations, the band structure shown in FIG. 2D may reveal the presence of edge states in the system. These edge states may appear in the shaded regions as lines crossing the band gaps. The presence and characteristics of these edge states may depend on the specific coupling parameters of the resonator network.

The transmission spectrum shown in FIG. 2C may provide information about the coupling of light into and out of the resonator network of FIG. 2B. The dips in the transmission may indicate the presence of an edge states where light is efficiently absorbed by the lattice. The depth and width of the transmission dips may be related to the coupling strengths and quality factors of the resonators in the array.

In some implementations, the pump frequency, indicated by the arrow in FIG. 2C, may be tuned to excite specific modes or edge states of the system. The choice of pump frequency may influence the generation of optical frequency combs in the resonator network. In some implementations, there may be two or more different pump frequencies.

FIGS. 2E-2G illustrate edge and bulk characteristics of the coupled ring resonator of the unit cell 212. These figures depict intensity distribution patterns in different configurations of the resonator array.

FIGS. 2E-2G shows three vertically arranged diagrams labeled as “Edge”, “Bulk”, and “Bulk”. FIG. 2E, labeled “Edge”, displays the light intensity pattern in the lattice when the edge states are excited. For edge states, light is confined only to the resonators on the edge/boundary of the lattice. The intensity of these edge states may be indicated by the color scale ranging from 0 to 1 shown on the right side of the diagram.

The diagram in FIG. 2F, labeled “Bulk”, presents the intensity distribution of bulk states in the resonator array. This intensity distribution occupies the resonators in the bulk of the lattice. The intensity of the bulk states may be indicated by the color scale ranging from 0 to 1 on the right side of the diagram.

The diagram in FIG. 2G, also labeled “Bulk”, shows another intensity pattern that also corresponds to bulk states, and highlights that bulk states may have different intensity distributions in the lattice. The intensity distribution may be indicated by the color scale ranging from 0 to 1 on the right side of the diagram.

In some cases, the edge states shown in the diagram of FIG. 2E may circulate around the perimeter of the resonator array, forming a traveling-wave super-ring resonator. The bulk states shown in the middle and bottom diagrams may occupy the interior of the resonator array. The intensity distributions depicted in FIGS. 2E-2G may provide insights into the spatial characteristics of edge and bulk states in the coupled ring resonator system and the intensity distribution in the lattice for the edge and the bulk states. As shown in FIGS. 2E-2G, the intensity distribution corresponding to the edge states is always confined to the boundary of the lattice and does not change appreciably for exciting different edge states, while the bulk state intensity distribution may vary significantly with the pump frequency. These distributions may vary depending on the specific coupling parameters and operational regime of the resonator array.

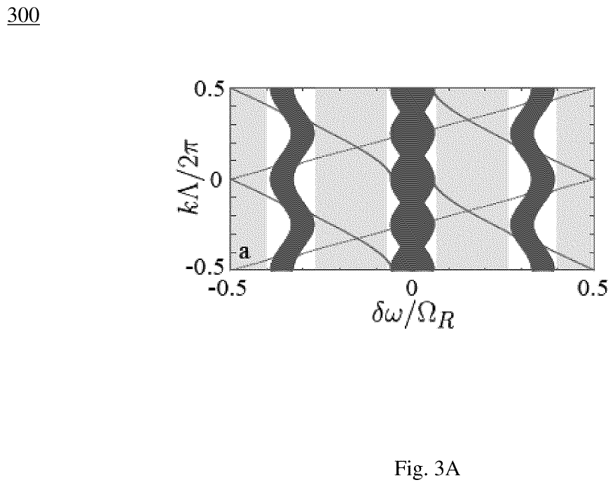

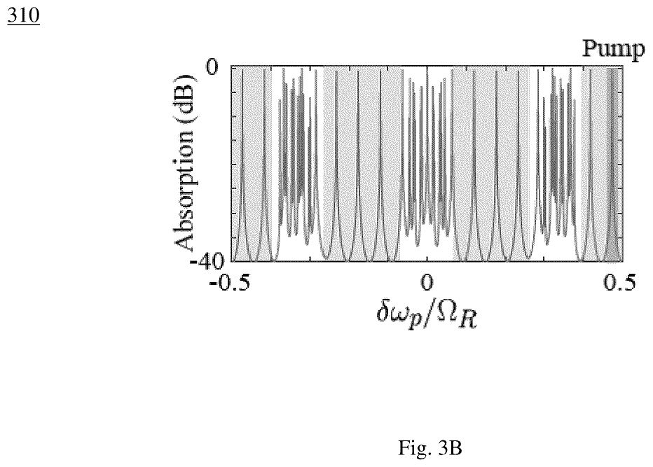

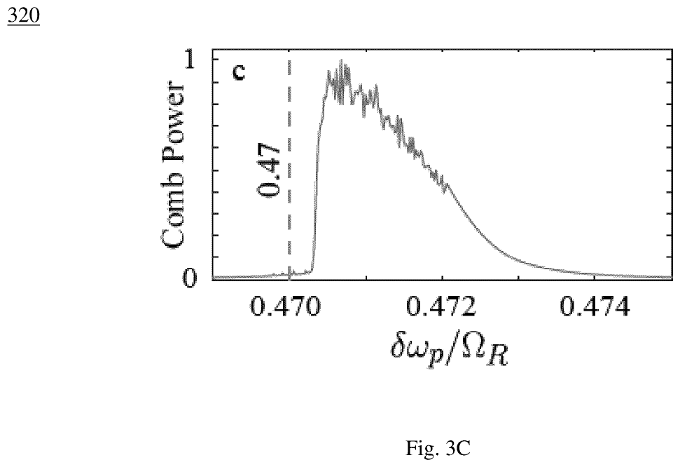

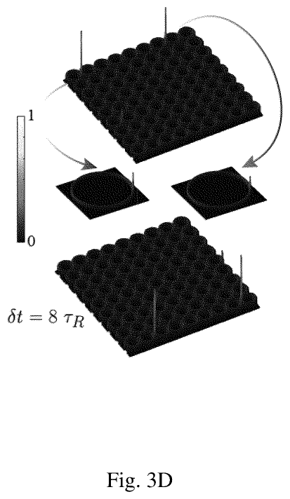

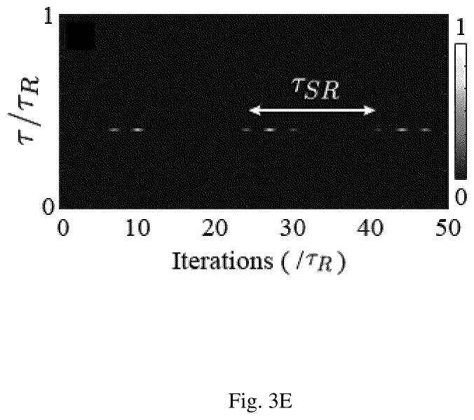

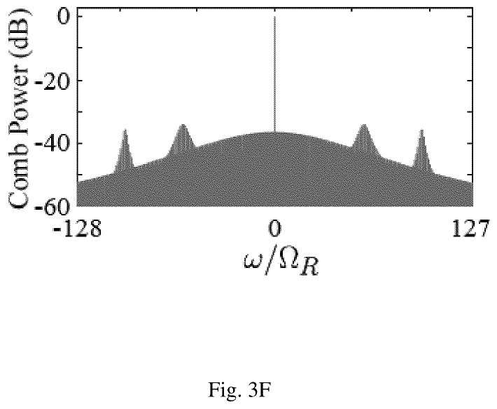

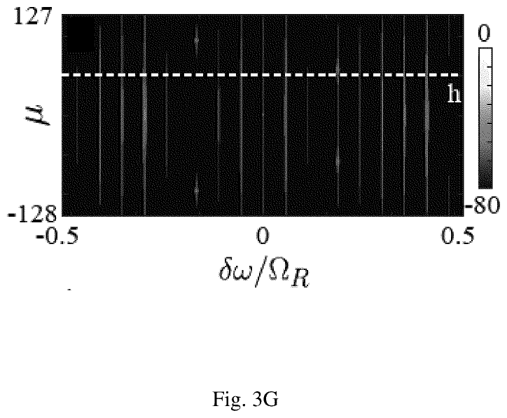

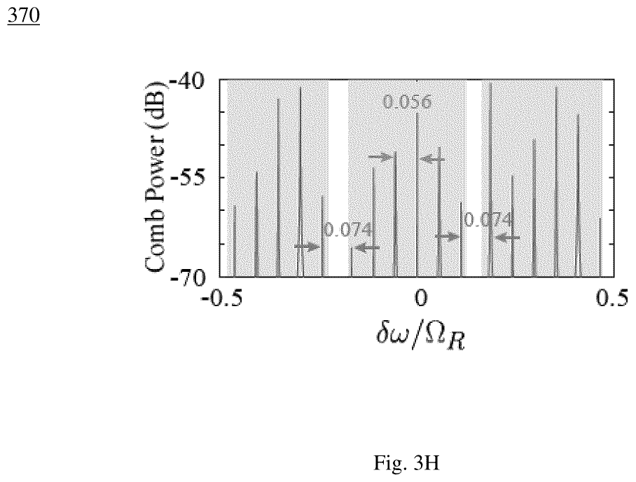

FIG. 3A illustrates a graph depicting the relationship between normalized frequency detuning (δω/ΩR) on the x-axis and normalized wavevector (kΛ/2π) on the y-axis for a specific implentation of the disclosed technology. As shown in FIG. 3A, the y-axis of the graph 300 spans from −0.5 to 0.5, while the x-axis extends from −0.5 to 0.5—one full free-spectral range (FSR) of the individual ring resonators. This reflects the periodicity of the frequency spectrum of the lattice and may indicate the existence of an anomalous floquet topological phase in the lattice.

The graph displays alternating regions of edge bands (shaded arca) and bulk bands. The diagonal lines in the shaded regions represent edge states. The width and shape of these bulk and edge bands may vary depending on the specific coupling parameters and topological phases. The slope of the edge states is related to the group velocity of the edge states and may vary depending on the specific coupling parameters and topological phases.

In some implementations, the specific features observed in this graph may depend on the coupling parameters of the resonator network and the topological phase in which the system operates. In particular, the presence and characteristics of the edge states represented by the diagonal lines may be particularly sensitive to these parameters.

FIG. 3B illustrates a graph 310 showing pump absorption characteristics plotted against normalized frequency detuning. The graph 310 displays a series of absorption peaks, with the absorption measured in decibels (dB) on the y-axis ranging from −40 to 0 dB. The x-axis shows the normalized frequency detuning δωp/ΩR ranging from −0.5 to 0.5.

The absorption peaks, representing regions of high absorption, appear as distinct clusters across the frequency range, with each cluster corresponding to edge or bulk states. The height and shape of these peaks may provide information about the strength and nature of the absorption at different frequency detunings. The alternating clusters of peaks reflect the band structure, with interleaved edge and bulk states, of the coupled ring resonator system.

In some implementations, the spacing between the peak clusters may be related to the free spectral range of the individual ring resonators in the array. The width and intensity of the peaks within each cluster may depend on the coupling strengths between resonators and the specific topological phase of the system.

The absorption characteristics displayed in FIG. 3B may provide insights into the resonant behavior of the coupled ring resonator array. The frequency detuning values where absorption peaks occur in shaded areas correspond to edge states of the system. The depth and width of these absorption peaks may be influenced by factors such as the quality factor of the resonators and the coupling between edge and bulk states.

The pump absorption characteristics illustrated in FIG. 3B provide valuable insights for optimizing the generation of optical frequency combs in the coupled ring resonator system. By analyzing the absorption peaks and their corresponding frequency detunings, the most effective pump frequencies for exciting specific edge or bulk states within the resonator array can be identified. The choice of pump frequency relative to these absorption features is crucial, as it directly influences the efficiency of energy transfer into the system and the subsequent formation of coherent comb lines.

For instance, pumping at frequencies corresponding to strong absorption peaks may lead to more efficient excitation of edge states, potentially resulting in the generation of robust topological soliton molecules. Conversely, pumping at frequencies between absorption peaks or in regions of lower absorption may yield different comb characteristics, such as altered spectral bandwidth or comb line spacing. The relationship between pump frequency and absorption features also affects the phase-matching conditions necessary for efficient four-wave mixing processes, which are fundamental to comb generation.

Furthermore, the periodic nature of the absorption spectrum, as evident in FIG. 3B, reflects the underlying band structure of the coupled resonator array operating in the anomalous floquet topological phase. This periodicity offers multiple potential pump frequencies within each free spectral range, allowing for fine-tuning of the comb generation process. By carefully selecting the pump frequency based on these absorption characteristics, the spectral properties of the generated combs, such as their bandwidth, power distribution, and the presence of incommensurate frequency spacings between comb lines can be tailored.

FIG. 3C illustrates a graph 320 showing comb power as a function of normalized frequency detuning. The y-axis of the graph 310 represents the comb power normalized between 0 and 1. This normalization may allow for comparison of relative comb power levels across different operational regimes or system configurations. As shown in FIG. 3C, as the pump frequency detuning is decreased, the comb power increases gradually, reaching a peak at a normalized frequency detuning of approximately 0.471. This rise in comb power indicates the formation of a comb in the coupled ring resonator system.

After reaching the peak, the comb power undergoes a drastic decline extending to approximately 0.469 on the x-axis. This steep decline represents a region where the comb lines are mode locked and generate soliton molecules in the array.

In some implementations, the gradual rise and subsequent steep decline in comb power (with decreasing pump frequency) may be associated with the formation and stabilization of soliton states in the coupled ring resonator array. The specific shape of this curve may depend on factors such as the coupling strengths between resonators, the pump power and frequency, and the topological phase of the system.

FIG. 3C includes a vertical dashed line intersecting the x-axis at 0.47. This line indicates a particular frequency detuning of interest, in which mode-locked incommensurate combs and soliton molecules in the array are generated.

In some implementations, the relationship between comb power and normalized frequency detuning shown in FIG. 3C may be used to identify optimal pump frequencies for generating stable and high-power optical frequency combs in the coupled ring resonator system. The choice of pump frequency relative to the features observed in this graph may affect the efficiency and spectral characteristics of the generated combs.

FIG. 3D illustrates an intensity distribution 330 pattern in a two-dimensional array of coupled ring resonators at different time intervals. The array consists of a grid-like arrangement of resonators where the intensity patterns are indicated with the height of plot. The intensity distribution 330 patterns manifest as raised structures on the grid surface, demonstrating the spatial distribution of optical power within the resonator array. These patterns may represent the formation and propagation of soliton states within the coupled resonator system.

The upper grid displays the initial intensity distribution 330 state, while the lower grid shows the subsequent state after the time interval δt. The intensity distribution 330 demonstrates how soliton molecule pulses propagate through the lattice structure, with δt=8τR representing the state of soliton molecule pulses at a later time interval from an initial state.

The intensity distribution 330 is represented by a color gradient scale from 0 to 1, shown on the left side of the figure. In some cases, the color gradient may indicate the relative optical power or field intensity within the resonator array.

In some cases, the intensity distribution 330 may reveal the presence of self-organized floquet topological soliton molecules in the resonator network. These soliton molecules may exhibit phase-locking across multiple rings on the edge of the lattice. The phase-locked nature of these soliton molecules may be inferred from the presence of sharp peaks in the intensity pattern.

As time evolves from the upper grid to the lower grid, the intensity distribution 330 patterns maintain their overall structure while shifting position. This behavior may indicate the propagation of soliton molecules around the edge of the lattice. The preservation of the intensity distribution 330 pattern shape during propagation may suggest the robustness of these floquet topological soliton states. The time interval δt=8τR between the two states may be related to characteristic timescales of the system, such as the round-trip time in individual resonators or the propagation time around the entire array.

In some implementations, the intensity distribution 330 may show higher values along the edges of the grid, corresponding to the outer rings of the resonator array. This edge localization may be characteristic of topological edge states in the system.

The regular grid structure underlying the intensity distribution 330 patterns may reflect the physical arrangement of the resonators in the experimental setup. The spacing between grid points may correspond to the coupling distances between adjacent resonators in the array.

FIG. 3E depicts a graph 340 showing the evolution of normalized time τ/τR plotted against iterations. The x-axis of the graph 340 extends from 0 to 50 iterations, while the y-axis ranges from 0 to 1 in normalized time units. This normalization may be with respect to ΣR, which may represent the round-trip time in an individual ring resonator of the array. The data points show in in graph 340 may represent specific events or states in the evolution of the coupled ring resonator system. In some cases, these data points may correspond to the occurrence of soliton pulses or other coherent structures within the resonator array.

A double-headed arrow labeled “τSR” indicates the round-trip time in the super-ring resonator formed by the edge states of the coupled ring resonator array. In some cases, the τSR interval may be related to the propagation time of soliton molecules or other coherent structures around the perimeter of the resonator array.

A color scale bar appears on the right side of the graph 340, ranging from 0 (black) to 1 (white). As used in FIG. 3E, this color scale indicates the intensity or amplitude of the optical field at different points in the evolution of the system.

In some implementations, the pattern of data points and the τSR interval shown in FIG. 3E may provide insights into the temporal dynamics of soliton formation and propagation in the coupled ring resonator array. The relationship between the spacing of these data points and the τSR interval may reveal information about the synchronization or phase-locking of soliton states in the system. For example, the regular spacing between the data points may indicate a periodic behavior in the system. This periodicity may be related to the round-trip time of solitons or other optical structures circulating within the resonator array.

FIG. 3F depicts a graph 350 showing comb power measured in decibels (dB) plotted against normalized frequency @/ΩR. The frequency range shown in FIG. 3F spans from −128 to 127 on the horizontal axis, representing a wide spectral coverage of the generated comb. The vertical axis shows power measurements in decibel units, providing information about the relative strengths of different frequency components in the comb. The graph 350 displays a symmetrical power distribution centered at zero frequency, with the power levels ranging from approximately −60 dB to 0 dB.

The spectrum depicted in graph 350 features a broad central peak, which corresponds to the pump frequency, and multiple smaller peaks on either side, which may represent generated comb lines. The central region exhibits a relatively smooth curve with power levels around −40 dB. Distinct spikes appear at approximately ±0.4 ω/ΩR with power levels reaching about −35 dB.

FIG. 3G depicts a graph 360 showing the spectrum of the generated comb, reorganized as a function of frequency detuning (δω/ΩR) on the x-axis and FSR index (μ) on the y-axis. The vertical lines in 360 indicate comb lines.

As shown in FIG. 3G, the vertical lines correspond to specific edge states in the coupled ring resonator system. The intensity variations along these lines may provide information about the relative strength of different spectral components at each FSR index. The pattern of discrete spectral features shown in FIG. 3G exhibits a distinctive structure, with the vertical lines forming a series of bands across the FSR index range. In some cases, this banded structure may indicate the presence of multiple edge bands in the generated frequency comb. The spacing between these bands and their relative intensities may reveal information about the incommensurate nature of the comb spectrum.

FIG. 3H depicts a graph 370, which is a cross-section of FIG. 3G along line h. Graph 370 shows comb power measurements in decibels (dB) plotted against normalized frequency detuning at a given FSR index. The graph displays multiple vertical peaks, corresponding to different comb lines, across a frequency range from −0.5 to 0.5 δω/ΩR, with power measurements ranging from approximately −70 dB to −40 dB.

The vertical peaks in the graph appear in clusters with varying heights. In some cases, these clusters may correspond to different edge bands in the generated frequency comb. The graph includes annotations showing specific frequency separation between the comb lines. The frequency spacing between comb lines in a single cluster is 0.056, while the frequency spacing between comb lines of adjacent clusters (edge bands) is 0.074. In some implementations, these different spacing measurements may suggest the presence of an incommensurate frequency comb, where the comb lines are not all equidistant in frequency.

The spacing between the peaks in the comb power spectrum may not be uniform, which may be characteristic of an incommensurate frequency comb. Despite this non-uniform spacing, the comb lines may still be phase-locked, maintaining a coherent phase relationship between different frequency components.

The frequency spacing between the comb lines can be tuned by tuning the coupling strengths θ_{A}, and θ_{B}. The incommensurate comb can be transformed into a commensurate comb where all the comb lines are equally spaced, like a regular single-resonator comb. These coupling strengths still correspond to the realization of the anomalous floquet topological phase in the lattice.

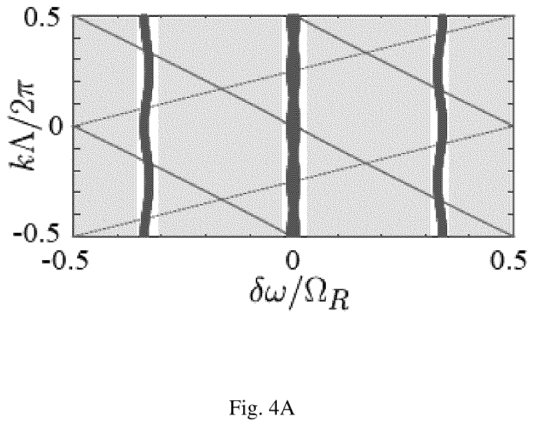

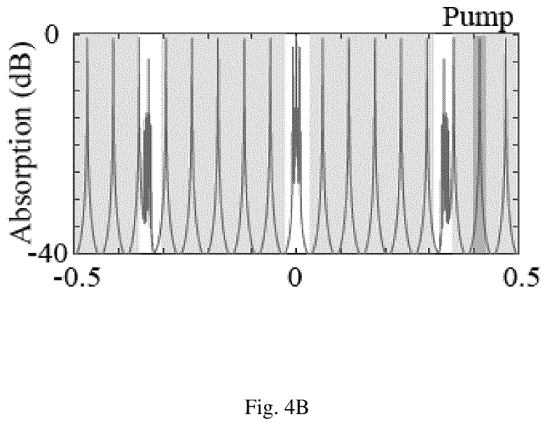

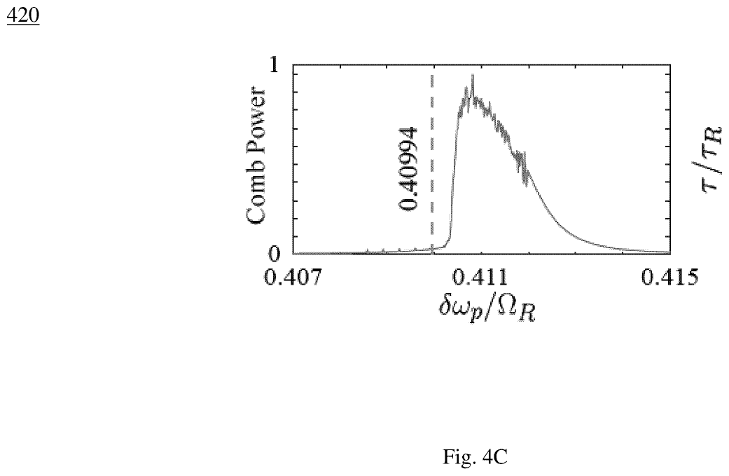

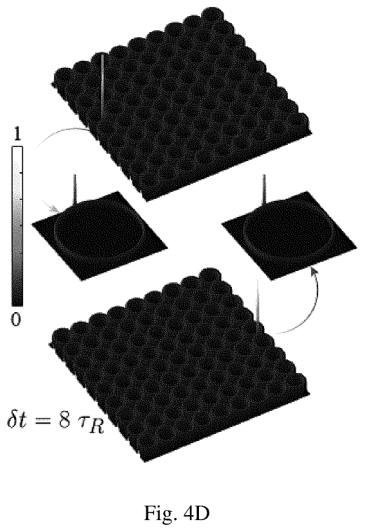

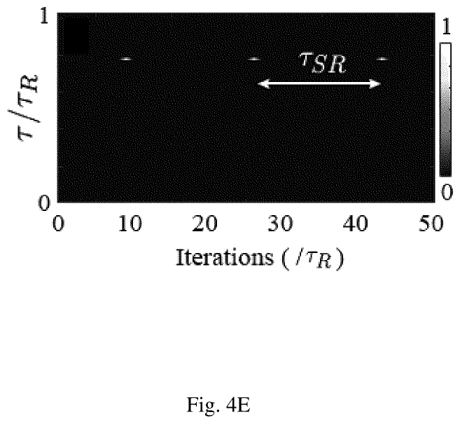

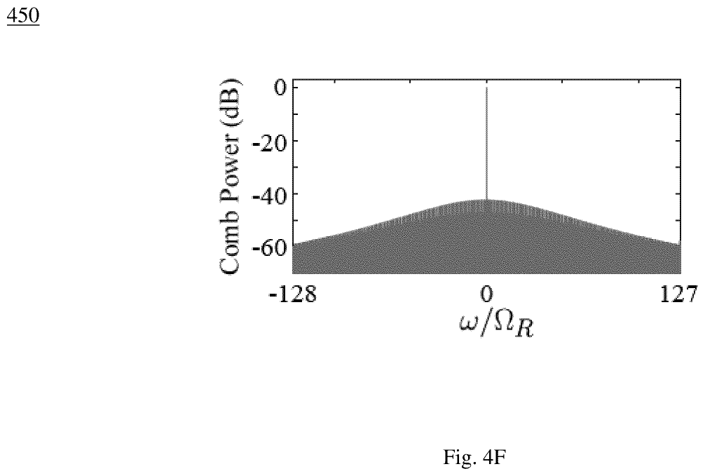

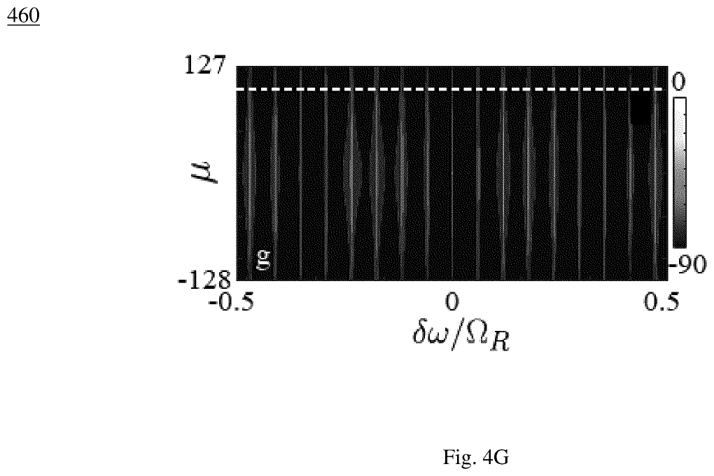

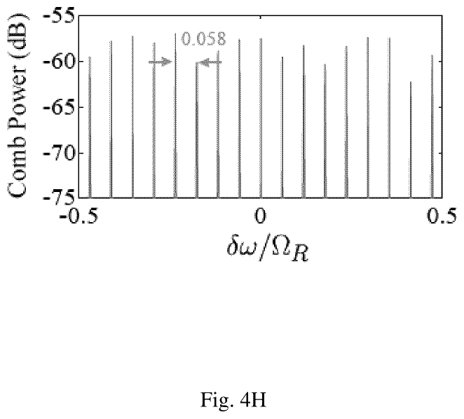

FIG. 4A depicts a graph 400 showing the relationship between normalized frequency detuning (δω/ΩR) on the x-axis and normalized wave vector (kΛ/2π) on the y-axis for a system with coupling parameters θ_{A}=0.49π, and θ_{B}=0.01π. The graph 400 spans from −0.5 to 0.5 on both axes and contains three distinct vertical bands positioned at approximately −0.5, 0, and 0.5 on the x-axis, representing the allowed bulk bands in the system. The shaded regions between the bulk bands correspond to the edge bands of the array. Diagonal lines intersect these bands at various angles, forming a crisscrossing pattern across the plot. These diagonal lines represent edge states that traverse the band gaps.

Comparing FIG. 4A to FIG. 3A, the bands in FIG. 4A appear more distinct and separated, indicating a clearer separation between bulk and edge states in this configuration. The shaded areas in FIG. 4A are more prominent compared to those in FIG. 3A, suggesting wider edge bands in this phase. Additionally, the pattern of diagonal lines in FIG. 4A appears more regular and distinct, reflecting a more linear dispersion of the edge states than observed in FIG. 3A. These differences arise from the different coupling parameters used in the two figures, with FIG. 4A representing a system closer to the Chern insulator phase.

FIG. 4B depicts an absorption spectrum graph 410 showing pump characteristics for the system with coupling parameters θ_{A}=0.49π, and θ_{B}=0.01π. The graph 410 displays absorption in decibels (dB) on the y-axis ranging from −40 to 0 dB, plotted against normalized frequency detuning (δωp/ΩR) on the x-axis spanning from −0.5 to 0.5. The absorption pattern consists of multiple narrow, sharp peaks of varying heights distributed symmetrically around the center point at 0, with the peaks in the shaded background representing edge states.

Comparing FIG. 4B to FIG. 3B, the absorption spectrum in FIG. 4B exhibits more distinct and regularly spaced peaks. This difference arises because the width of bulk bands is much smaller than that of edge bands in this configuration. The peaks in FIG. 4B are sharper and more well-defined than those in FIG. 3B, indicating a different resonant behavior in the coupled ring resonator system. The regular spacing between peaks in FIG. 4B relates to the band structure and energy levels of the system in this topological phase, which differs from the band structure observed in FIG. 3B.

FIG. 4C depicts a graph 420 showing comb power as a function of normalized frequency detuning for the system operating near the Chern insulator phase. The graph 420 displays comb power normalized between 0 and 1 on the y-axis plotted against normalized frequency detuning (δωp/ΩR) on the x-axis. As the pump frequency detuning is decreased, the comb power shows a gradual increase followed by a sharp decrease, with the peak occurring at a normalized frequency detuning value of approximately 0.411. A vertical dashed line intersects the x-axis at 0.40994, marking a specific point of interest on the curve.

Comparing FIG. 4C to FIG. 3C, both graphs show a similar pattern of increasing and then decreasing comb power as the pump frequency detuning decreases. However, the peak in FIG. 4C occurs at a different detuning value (approximately 0.411) compared to FIG. 3C (approximately 0.471). The profile in FIG. 4C exhibits a more asymmetric shape, with a steeper fall on the left side and a more gradual rise on the right side, whereas FIG. 3C shows a more symmetric rise and fall. These differences reflect how the comb generation process varies between the two different coupling parameter regimes.

FIG. 4D illustrates an intensity distribution pattern 430 in a two-dimensional array of coupled ring resonators at different time intervals. The intensity distribution 430 displays two identical square lattice configurations separated by a time interval δt=8ΣR, where τR represents the round-trip time in an individual ring resonator. The intensity is represented by a color scale from 0 to 1 shown on the left side of the figure. The distribution shows a single peak representing the formation of a single soliton at only one ring resonator on the edge of the lattice.

Comparing FIG. 4D to FIG. 3D, there is a significant difference in the intensity distribution patterns. While FIG. 3D shows multiple intensity peaks distributed across several ring resonators on the edge of the lattice (forming a soliton molecule), FIG. 4D displays only a single intensity peak localized to one ring resonator. This difference indicates that the system with parameters θ_{A}=0.49π and θ_{B}=0.01π forms a single soliton rather than a soliton molecule, demonstrating how the coupling parameters influence the spatial characteristics of the soliton formation in the resonator array.

FIG. 4E depicts a graph 440 showing normalized time evolution (t/tR) plotted against iterations for the system with coupling parameters θ_{A}=0.49π and θ_{B}=0.01π. The x-axis of the graph 440 extends from 0 to 50 iterations, while the y-axis ranges from 0 to 1 in normalized time units. A double-headed arrow labeled “τSR” indicates the round-trip time in the super-ring resonator formed by the edge states. The intensity is represented by a color scale from 0 to 1 shown on the right side of the figure.

Comparing FIG. 4E to FIG. 3E, there is a notable difference in the pattern of data points. While FIG. 3E shows a group of three pulses repeating within the time interval τSR, FIG. 4E displays the generation of single pulses with the same time interval τSR. This difference corresponds to the single soliton formation observed in FIG. 4D versus the soliton molecule formation in FIG. 3D. The pattern in FIG. 4E indicates a simpler temporal dynamic with individual solitons circulating around the edge of the lattice, whereas FIG. 3E shows a more complex dynamic with multiple phase-locked solitons forming a molecule. These differences in temporal behavior directly relate to the different coupling parameters used in the two configurations.

FIG. 4F depicts a graph 450 showing comb power measured in decibels (dB) plotted against normalized frequency (@/ΩR). The graph displays a symmetrical power distribution centered at zero frequency, with the power levels ranging from approximately −60 dB to −40 dB. The frequency range shown spans from −128 to 127 on the horizontal axis, representing a wide spectral coverage of the generated comb.

Comparing FIG. 4F to FIG. 3F, both graphs show a similar overall envelope shape with power levels in the same approximate range. However, FIG. 4F appears to have a smoother spectral profile with fewer pronounced peaks and valleys compared to FIG. 3F. This difference is because of the generation of a single soliton in FIG. 4D.

FIG. 4G depicts a graph 460 showing the spectrum of the generated comb as a function of frequency detuning (δω/ΩR) on the x-axis and FSR index (μ) on the y-axis. The vertical axis spans from −128 to 127, while the horizontal axis ranges from −0.5 to 0.5. The intensity is represented by a grayscale color map with values ranging from −90 to 0, as indicated by the scale bar on the right side of the graph. The graph displays a pattern of vertical lines corresponding to specific frequency components in the generated comb.

Comparing FIG. 4G to FIG. 3G, there is a significant difference in the pattern of vertical lines. While FIG. 3G shows an irregular pattern with varying spacing between the vertical lines, FIG. 4G displays a more regular pattern with consistent spacing between the lines. This difference indicates that the comb generated with parameters θ_{A}=0.49π and θ_{B}=0.01π has a more commensurate frequency spacing compared to the incommensurate spacing observed in FIG. 3G. The regular pattern in FIG. 4G suggests that this configuration produces a more conventional comb with equidistant frequency lines.

FIG. 4H depicts a graph 470 showing comb power in decibels (dB) plotted against normalized frequency detuning (δω/ΩR). The graph displays multiple vertical peaks across a frequency range from −0.5 to 0.5, with power measurements ranging from approximately −75 dB to −55 dB. The spacing between adjacent peaks is indicated as 0.058, and this spacing appears consistent across the entire frequency range.

Comparing FIG. 4H to FIG. 3H, there is a striking difference in the spacing between the comb lines. While FIG. 3H shows irregular spacing between peaks (with values of 0.074, 0.056, and 0.074 indicated), FIG. 4H displays a uniform spacing of 0.058 between all adjacent peaks. This regular spacing in FIG. 4H confirms that the system with parameters θ_{A}=0.49π and θ_{B}=0.01π generates a commensurate frequency comb with equidistant lines, in contrast to the incommensurate comb with irregularly spaced lines shown in FIG. 3H. This demonstrates how the coupling parameters can be tuned to transform an incommensurate comb into a commensurate one, as mentioned in the invention disclosure.

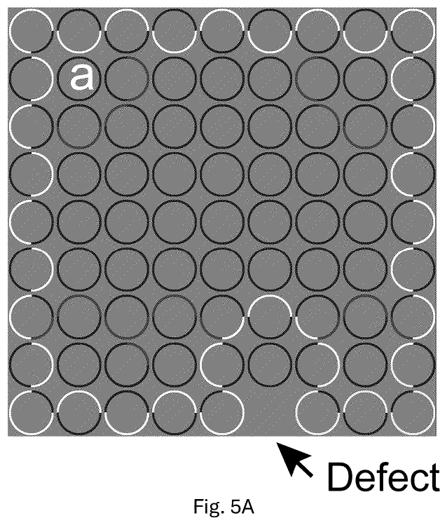

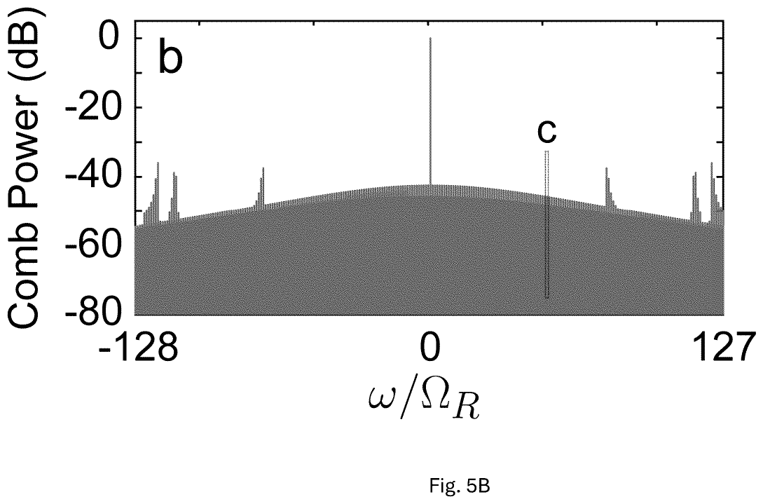

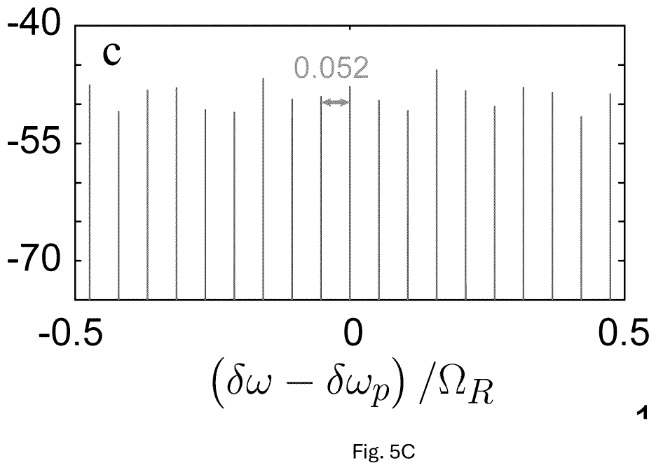

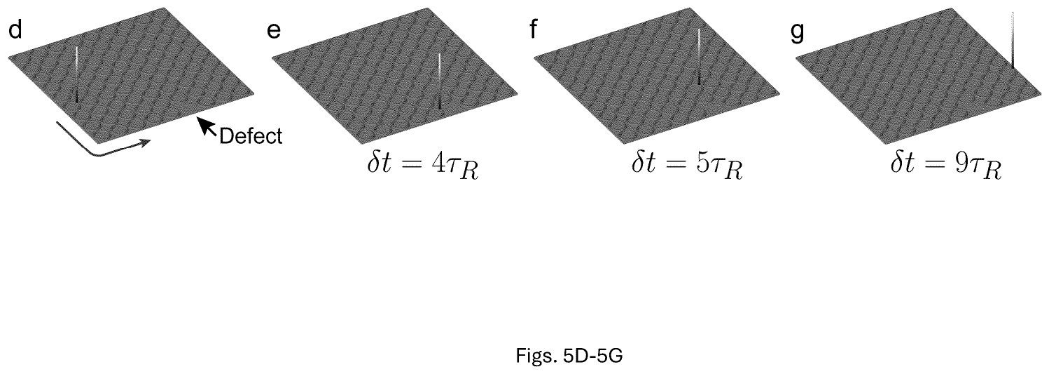

FIGS. 5A-5G illustrate the tunability of optical frequency combs using topological edge states.

FIG. 5A illustrates the robustness of topological edge states in the presence of defects within the two-dimensional array of coupled resonators. The figure depicts an intensity plot showing the propagation of edge states around a deliberately introduced defect in the lattice structure, such as a missing ring resonator, creating a discontinuity in the otherwise regular array pattern.

The edge state, visualized as a high-intensity region, demonstrates its ability to navigate around the defect without scattering into the bulk of the lattice. This behavior is a key characteristic of topological edge states, showcasing their inherent resilience against local perturbations. The uninterrupted circulation of the edge state around the defect effectively increases the path length of the edge state's propagation.

This increased path length has significant implications for the properties of the super-resonator formed by the edge states. Specifically, it leads to an extension of the effective length of the edge state super-resonator. This extension directly impacts the frequency characteristics of the generated optical frequency comb, as the comb line spacing is inversely proportional to the round-trip time of the super-resonator.

The ability to manipulate the effective length of the edge state super-resonator through the introduction of controlled defects provides a novel mechanism for fine-tuning the properties of the generated frequency comb. This feature offers a degree of tunability that is challenging to achieve in conventional single-resonator comb sources, potentially enabling more precise control over comb line spacing and other spectral characteristics.

The comb spectrum displayed in FIG. 5B illustrates the frequency distribution of the optical frequency comb generated by the two-dimensional array of coupled resonators with the defect. This spectrum provides information about the impact of the defect on the comb generation process. The presence of the defect, which alters the path of the edge states, is expected to modify the spectral characteristics of the generated comb compared to a defect-free lattice. The comb lines in this spectrum may exhibit changes in their spacing, intensity distribution, or overall spectral envelope, reflecting the altered dynamics of the edge state super-resonator. By comparing this spectrum to that of a defect-free lattice (such as those depicted in FIGS. 3F and 4F), one can observe how the topological robustness of the edge states translates into resilience or adaptability in the comb generation process, potentially offering new avenues for comb engineering and spectral tailoring in topological photonic systems.

FIG. 5C presents a magnified view of the comb spectrum in the shaded region, showing equally spaced (commensurate) comb lines with a spacing of 0.052. This spacing is smaller than the 0.058 spacing observed in a similar commensurate comb generated without the defect, demonstrating how the increased length of the edge state super-resonator decreases the comb line spacing.

The reduction in comb line spacing from 0.058 to 0.052 demonstrates the tunability of the optical frequency comb through controlled manipulation of the edge state super-resonator's effective length. This tunability may be achieved by introducing one or more defects, such as a detuning a ring resonator frequency by thermal effects, in the two-dimensional array. The defect causes the edge states to route around it, effectively increasing the path length of the super-resonator formed by these edge states.

This increase in path length directly impacts the round-trip time of light circulating in the super-resonator, which in turn affects the frequency spacing of the generated comb lines. The inverse relationship between the super-resonator's length and the comb line spacing allows for precise control over the comb's spectral characteristics. This method of tuning provides a unique advantage over conventional single-resonator comb sources, where adjusting the comb line spacing often requires changing the physical dimensions of the resonator itself.

The ability to fine-tune the comb line spacing through topological manipulation offers significant potential for applications requiring precise frequency control, such as in spectroscopy, metrology, and telecommunications. Moreover, the topological nature of the edge states ensures that this tuning mechanism is robust against minor imperfections or variations in the lattice structure, potentially leading to more stable and reliable comb sources.

FIGS. 5D-5G demonstrate the circulation of the soliton pulse generated in the lattice at different time intervals (8τ=0, 4τR, 5τR, and 9τR, respectively). The soliton pulse can be observed routing around the defect while maintaining its coherence and shape without scattering into the bulk. This topological robustness enables tunable comb line spacing, which is challenging to achieve in conventional single-resonator combs and could enable applications in ultra-low-noise RF signal synthesis and processing on photonic chips.

A number of implementations have been described. Nevertheless, it will be understood that various modifications may be made without departing from the spirit and scope of the disclosure. Accordingly, other implementations are within the scope of the following claims.

What is claimed:

1. An optical frequency comb source comprising:
a two-dimensional array of coupled resonators with spatially varied coupling strengths operating in an anomalous floquet topological phase having topological edge states appearing in all topological band gaps, the array generating, when pumped with radiation at a frequency corresponding to one of the topological edge states, an incommensurate optical frequency comb having multiple edge bands irregularly spaced in the frequency domain.

2. The optical frequency comb source of claim 1, wherein the two-dimensional array comprises a lattice of evanescently coupled resonators.

3. The optical frequency comb source of claim 1, wherein one instantiation of the resonators uses a ring resonator.

4. The optical frequency comb source of claim 2, wherein the spatially varied coupling strengths are parameterized as κa=sin (|θA|) and κb=sin (|θB|), and θA and θB are coupling parameters.

5. The optical frequency comb source of claim 4, wherein θA and θB are chosen to operate in the anomalous Floquet topological phase.

6. The optical frequency comb source of claim 1, further comprising at least one input-output waveguide coupled to at least one resonator for injecting the pump radiation and out-coupling the generated comb.

7. The optical frequency comb source of claim 1, wherein its absorption spectrum comprises alternating bands of edge and bulk states.

8. The optical frequency comb source of claim 1, wherein the incommensurate optical frequency comb is associated with floquet topological soliton molecules circulating at an edge of the array.

9. The optical frequency comb source of claim 8, wherein the floquet topological soliton molecules exhibit phase-locking across multiple rings on the edge of the array.

10. The optical frequency comb source of claim 1, wherein the ring resonators have an anomalous dispersion.

11. The optical frequency comb source of claim 1, wherein the incommensurate frequency comb can be tuned to a commensurate comb, with equal frequency spacing, by tuning θA and θB.

12. The optical frequency comb source of claim 1, wherein the frequency spacing between the comb lines can be tuning by creating a defect on the edge of the lattice and tuning the effective length of the edge.

13. The optical frequency comb source of claim 1, wherein the frequency spectrum is topologically robust against imperfections and disorders in the ring resonators of the lattice.

14. A method of generating an optical frequency comb, comprising:
providing a two-dimensional array of coupled resonators having spatially varied coupling strengths and operating in an anomalous floquet topological phase with topological edge states appearing in all topological band gaps; and
generating an incommensurate optical frequency comb having multiple edge bands irregularly spaced in the frequency domain by pumping the two-dimensional array at a frequency corresponding to one of the topological edge states.

15. The method of claim 14, wherein the two-dimensional array comprises a lattice of evanescently coupled resonators.

16. The method of claim 15, wherein the spatially varied coupling strengths are parameterized as κa=sin (|A|) and κb=sin (|θB|), where θA and θB are coupling parameters.

17. The method of claim 16, wherein θA and θB are chosen to operate in the anomalous Floquet topological phase.

18. The method of claim 14, wherein the incommensurate optical frequency comb comprises comb lines that are not equidistant but are phase-locked.

19. The method of claim 18, wherein the incommensurate optical frequency comb spans multiple edge bands interleaved by bulk bands of the two-dimensional array.

20. The method of claim 14, wherein generating the incommensurate optical frequency comb comprises forming floquet topological soliton molecules that circulate at an edge of the array.
